(19) United States
(12) Patent Application Publication
(10) Pub. No.: US 2018/0270581 A1
(43) Pub. Date: Sep. 20, 2018

(54) MEMBRANE PLATE MADE OF CERAMIC MATERIAL

(71) Applicant: Sound Solutions International Co., Ltd., Beijing (CN)

(72) Inventors: Christian Lembacher, Gramatneusiedl (AT); Michael Wohlgenannt, Vienna (AT); Nikolaos Yamvrias, Purkersdorf (AT); Corinna Zehetmayr, Vienna (AT)

(21) Appl. No.: 15/919,778

(22) Filed: Mar. 13, 2018

(30) Foreign Application Priority Data
Mar. 15, 2017 (AT) A 50207/2017

(51) Int. Cl. H04R 9/06; H04R 9/02; H04R 7/18; H04R 7/04

(52) U.S. Cl. CPC H04R 9/06; H04R 9/025; H04R 2499/11; H04R 7/04; H04R 2307/023; H04R 7/18

(57) ABSTRACT

A dynamic loudspeaker driver, comprising a magnet system; a membrane which comprises a diaphragm and a flexible annulus surrounding the diaphragm, the diaphragm being movably mounted with respect to the magnet system by means of the annulus; a voice coil attached to the diaphragm and operatively coupled with the magnet system; a diaphragm plate attached to the diaphragm, the diaphragm plate being made of or comprising a ceramic material.

### CROSS-REFERENCE TO RELATED APPLICATIONS

This application claims priority to Austrian Patent Application No. A50207/2017, filed on Mar. 15, 2017, which is hereby incorporated by reference in its entirety.

### TECHNICAL FIELD

The invention relates to a dynamic loudspeaker driver, to a loudspeaker comprising the dynamic loudspeaker driver and to a mobile device, such as a mobile phone, comprising the loudspeaker.

### BACKGROUND

A dynamic loudspeaker driver usually comprises a magnet system, a diaphragm movably mounted with respect to the magnet system, and a voice coil attached to the diaphragm. The magnet system comprises a magnet and the voice coil is operatively coupled with the magnet. Usually, a loudspeaker comprises an enclosure and at least one dynamic loudspeaker driver mounted in the enclosure.

When operating, an electric signal is applied to the voice coil, for instance, by an amplifier. Then, the diaphragm moves with respect to the magnet system and with respect to the enclosure in response to the electric signal, resulting in moving air. A sound pressure level of the loudspeaker depends on the air moved by the diaphragm.

When moving, the diaphragm is subjected to air pressure of the ambient air and the air within the enclosure, forming a load for the moving diaphragm. Since the diaphragm is not absolutely stiff, this pressure results in deforming the diaphragm, potentially reducing the sound quality of the loudspeaker.

### BRIEF SUMMARY

It is an object of the present invention to provide a dynamic loudspeaker driver with an improved diaphragm plate.

Another object of the invention is to provide an improved loudspeaker and a further object of the invention is to provide an improved mobile device, for instance, a mobile phone.

The first object of the invention is achieved by means of a dynamic loudspeaker driver comprising a magnet system; a membrane which comprises a diaphragm and a flexible annulus surrounding the diaphragm, the diaphragm being movably mounted with respect to the magnet system by means of the annulus; a voice coil attached to the diaphragm and operatively coupled with the magnet system; a diaphragm plate attached to the diaphragm, the diaphragm plate being made of or comprising a ceramic material. The ceramic material may be reinforced, e.g. by means of fibers such as glass fibers or carbon fibers etc.

Due to the high stiffness at a relative low weight of ceramic based materials a very good acoustic performance of the loudspeaker driver can be achieved referring to frequency range by using such materials for the diaphragm plate. Also, a high robustness of the diaphragm plate against environmental influences can be achieved.

The further objects of the invention are achieved by means of a loudspeaker comprising an enclosure and the dynamic loudspeaker driver mounted in the enclosure, and a mobile device comprising this loudspeaker. The mobile device may, for instance, be a mobile phone.

The dynamic loudspeaker driver comprises the membrane with the diaphragm. Preferably the diaphragm is semi-rigid. Furthermore, the diaphragm is movably mounted with respect to the magnet system by means of the annulus. When mounted in the enclosure, then the diaphragm is also movable with respect to the enclosure. The enclosure is preferably a closed enclosure. When the flat diaphragm moves away from the enclosure, then the pressure of the ambient air of the enclosure acts as a load, and when the flat diaphragm moves towards the enclosure, then the pressure of the air within the enclosure acts also as a load. By means of using a ceramic material for producing the diaphragm plate , which results in a very stiff diaphragm plate , the acoustic performance of the loudspeaker is increased very much.

The annulus may, for instance, be attached directly to the magnet system. The dynamic loudspeaker driver may comprise a basket. Then, the magnet system is preferably attached to the basket and the flexible annulus is attached to the basket.

When mounted in the enclosure, the membrane provides a barrier between the air of the enclosure and the ambient air of the loudspeaker. When operating, an electric signal is applied to the voice coil, for instance, by an amplifier. Then, the voice coil and thus the diaphragm moves with respect to the magnet system and with respect to the enclosure in response to the electric signal, resulting in moving air.

The diaphragm is movably mounted with respect to the magnet system by means of the annulus. A further purpose of the annulus may be, if there is no electric signal applied to the voice coil, to move the diaphragm to a centered position relative to the magnet system. The diaphragm plate itself may be between 80 μm and 320 μm thick, preferably about 120 μm thick.

According to an embodiment, the diaphragm comprises a first surface and a second surface, the second surface being opposite to the first surface, wherein the diaphragm plate is attached either to the first surface or the second surface of the diaphragm. The dynamic loudspeaker driver may be relatively little and is preferably meant for a mobile device. In particular, the first or second surface of the diaphragm plate each may have an area less than 2 cm². Particularly this area may be between 0.5 cm² and 1.7 cm². Preferably, the area of the flat surface may be around 1.0 cm².

In an embodiment, the diaphragm plate covers at least 80%, of the first or second surface of the diaphragm.

According to an embodiment, the diaphragm plate comprises at least a first and a second layer, wherein one of the first and the second layer is made of the ceramic material and the other of the first and the second layer is made of an electrical conductive material. In an embodiment the diaphragm plate may comprise a base layer and a conductive layer attached thereto, wherein the base layer is made of the ceramic material and the conductive layer is made of an electrical conductive material.

To achieve a good mechanical coupling of the diaphragm plate and the diaphragm the diaphragm can be a flat diaphragm and the diaphragm plate can have a flat surface facing the diaphragm. It is of particular advantage in this context that the flat surface of the diaphragm plate has an area less than 2 cm².

The diaphragm and the flat surface of the diaphragm plate may, for instance, be circular, oval, or rectangular. It should be mentioned that all possible shapes of the diaphragm plate can be combined with all possible shapes of the diaphragm e.g. a circular, oval or elliptical diaphragm plate can be attached to a rectangular diaphragm et vice versa.

According to an embodiment, the ceramic material is an alumina ceramic and/or a hydrocarbon ceramic. As already mentioned above the ceramic material may also be reinforced, e.g. by means of fibers.

In an embodiment, the diaphragm plate has a thickness between 0.05 mm and 1.6 mm.

Preferably the diaphragm plate has a flexural strength between 200 and 300 500 MPa.

According to an embodiment the diaphragm plate may comprise an at least partially cupped and/or curved surface. Furthermore, the diaphragm may comprise at least one opening.

### BRIEF DESCRIPTION OF THE DRAWINGS

These and other aspects, features, details, utilities, and advantages of the invention will become more fully apparent from the following detailed description, appended claims, and accompanying drawings, wherein the drawings illustrate features in accordance with exemplary embodiments of the invention, and wherein:

FIG. 1 is a top view of a mobile phone;

FIG. 2 and FIG. 3 are each a loudspeaker of the mobile phone;

FIG. 4 is a side and sectional view of a dynamic loudspeaker driver of the loudspeaker;

FIG. 5 is a top view of the dynamic loudspeaker driver;

FIG. 6 is a diaphragm with a diaphragm plate of the dynamic loudspeaker driver;

FIG. 7 is a diaphragm of the loudspeaker;

FIG. 8 is a further embodiment of a diaphragm with a diaphragm plate of the dynamic loudspeaker driver;

FIG. 9 is a further embodiment of a diaphragm with a diaphragm plate of the dynamic loudspeaker driver;

FIG. 10 is a further embodiment of a diaphragm with a diaphragm plate of the dynamic loudspeaker driver;

FIG. 11 is a further embodiment of a diaphragm with a diaphragm plate of the dynamic loudspeaker driver.

### DETAILED DESCRIPTION

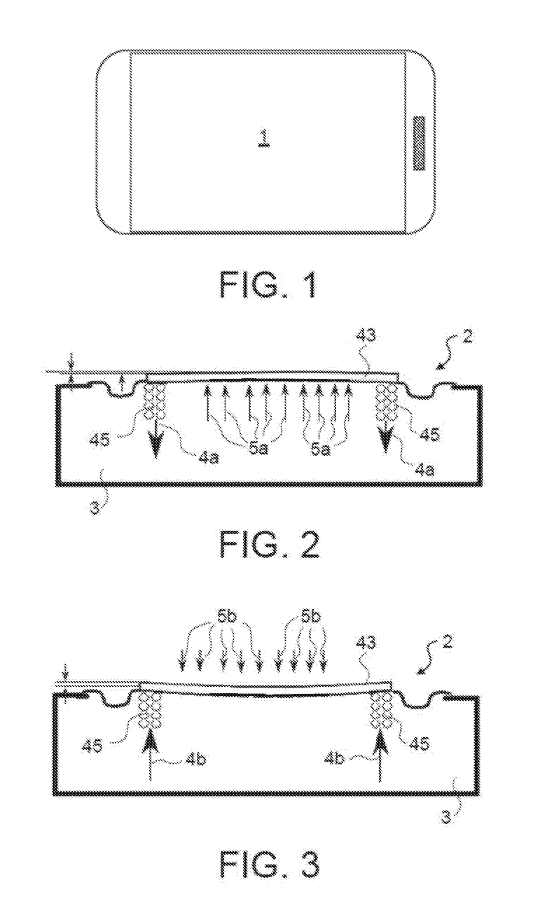

FIG. 1 shows a mobile phone 1 as an example of a mobile device. The mobile phone 1 comprises a microphone, a wireless sender/receiver unit and a loudspeaker 2 schematically shown as side and sectional views in FIGS. 2 and 3.

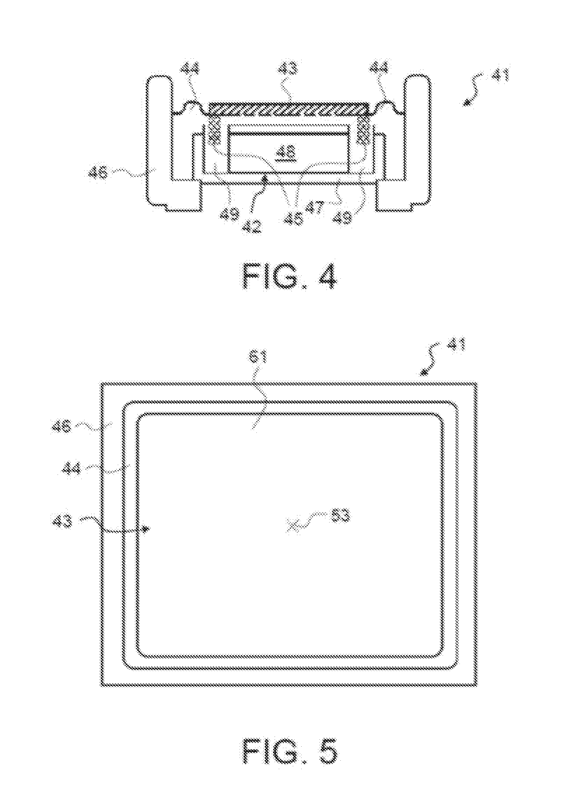

The loudspeaker 2 comprises an enclosure 3 and a dynamic loudspeaker driver 41 shown as a side and sectional view in FIG. 4. FIG. 5 shows a top view of the loudspeaker 2. The enclosure 3 is in particular a sealed or closed enclosure 3 and the dynamic loudspeaker driver 41 is mounted in the enclosure 3.

The dynamic loudspeaker driver 41 comprises a magnet system 42, a membrane, and a voice coil 45. The membrane comprises a diaphragm 43 and a flexible annulus 44 surrounding the diaphragm 43. Preferably the diaphragm is semi-rigid. The voice coil 45 is attached to the diaphragm 43 by means, for instance, of a glue. The diaphragm 43 is movably mounted with respect to the magnet system 42 by means of the annulus 44.

The dynamic loudspeaker driver 41 further comprises a basket 46. The annulus 44 is attached to the basket 46.

The magnet system 42 comprises a pot 47 and a magnet 48. The pot 47 and the magnet 48 form an air gap 49. The voice coil 45 is located within the air gap 49 and is operatively coupled with the magnet 48.

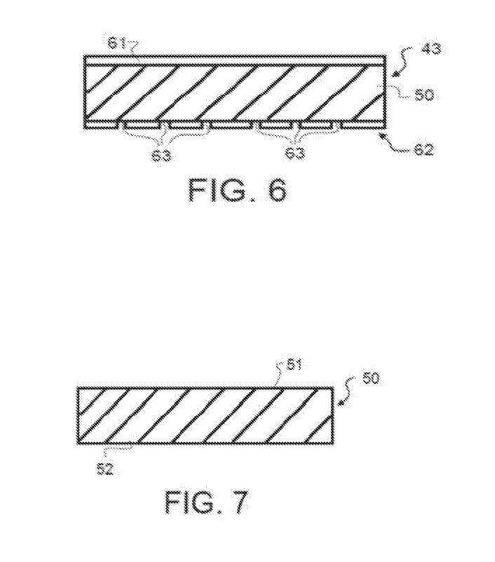

A side view of the diaphragm 43 is shown in FIG. 6.

The diaphragm 43 may have a circular, an oval shape or, as shown in FIG. 5 a rectangular shape. Accordingly, the diaphragm plate 61 may be of a circular, oval or rectangular shape as well. It should be mentioned, that in principle all possible shapes of diaphragm plate s 61 can be combined with all possible shapes of diaphragms 43, e.g. an oval diaphragm plate can be attached to a rectangular diaphragm.

The diaphragm 43 comprises a body 50 serving as a substrate shown as a side view in FIG. 7, and a diaphragm plate 61. The body 50 may be made of plastics, in particular made of foamed plastics. According to an embodiment the diaphragm itself may comprise at least two layers of different materials. According to another embodiment the diaphragm 43 may be realized by means of a single layer, e. g. in the form of a foil, as well.

The diaphragm plate 61 comprises a ceramic material or is made of a ceramic material. The ceramic material may be an alumina ceramic and/or a hydrocarbon ceramic. In an embodiment the diaphragm plate 61 comprises at least a first and a second layer, wherein one of the first and the second layer is made of the ceramic material and the other of the first and the second layer is made of an electrical conductive material. According to an embodiment the diaphragm plate 61 may comprise a base layer made of (fiber-reinforced) ceramic and a conductive layer made of an electrical conductive material.

The body 50 of the diaphragm comprises a first surface 51 and a second surface 52. The diaphragm plate 61 is preferably attached to and covers the first surface 51.

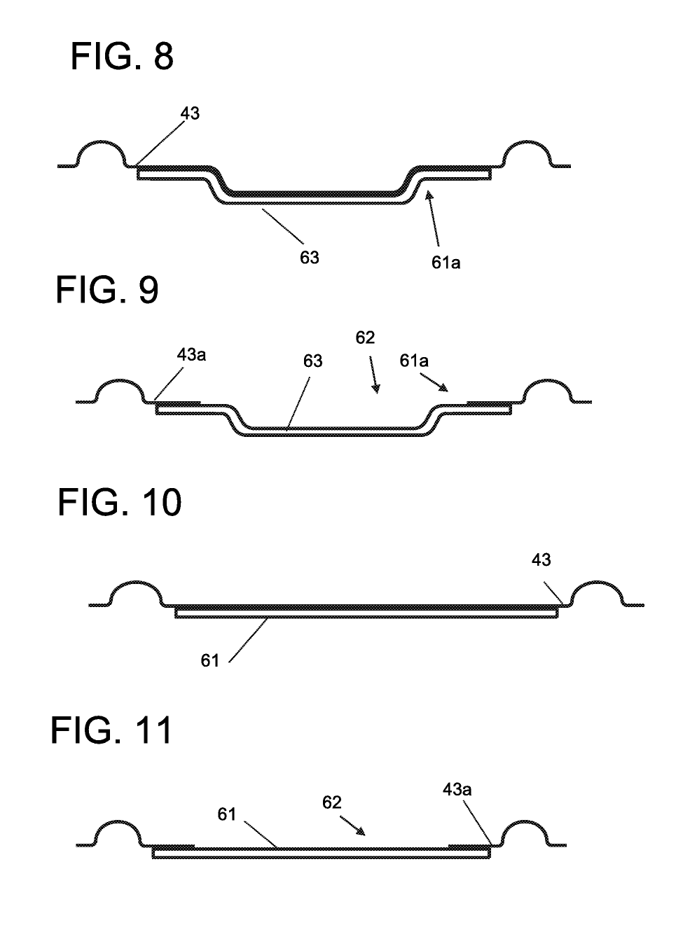

But, as shown in FIGS. 8-11 the diaphragm plate 61, 61a may also be attached to the second surface 52.

In the present embodiment, the second surface 52 of the substrate 50 faces towards the magnet system 42 and the first surface 51 faces away from the magnet system 42.

The diaphragm plate 61 is a continuous plate covering at least 80% of the first surface 51. Preferably the diaphragm plate 61 covers the entire area of the first surface 41 51 or the second surface 52 of the diaphragm 43.

The diaphragm 43 may be a flat diaphragm 43. But, according to FIGS. 8 and 9 the diaphragm plate 61a may comprise a cupped and/or curved portion 63. Preferably the portion 63 is located in a central part of the diaphragm plate 61a. As shown in FIG. 8 the diaphragm 43 may follow the shape of the diaphragm plate 61a.

As is shown in FIG. 9 the diaphragm 43a may comprise a central opening 62. According to this embodiment the diaphragm plate 61a is attached to an edge of the diaphragm 43a surrounding the opening 62.

Preferably, the first surface 51 and the second surface 52 each have an area of less than 2 cm², particularly between 0.5 cm² and 1.7 cm². Preferably, the flat surface has an area of around 1.0 cm². The flat diaphragm 43 may be between 80 μm and 320 μm thick, preferably about 120 μμm thick. The diaphragm plate 61 also may have a flat surface facing the diaphragm 43. The flat surface of the diaphragm plate 61 preferably has an area less than 2 cm². According to a preferred embodiment the diaphragm plate 61 has a thickness between 0.05 mm and 1.6 mm and a flexural strength between 200 and 300500 MPa.

The diaphragm plate 61 may be bonded or welded to the diaphragm 43, 43a. Alternatively, the diaphragm 43, 43a and the diaphragm plate 61 may be connected to each other by using a molding process.

When operating, an electric signal is applied to the voice coil 45, for instance, by an amplifier. Then, the diaphragm 43 moves with respect to the magnet system 42 in response to the electric signal, resulting in moving air.

FIG. 2 illustrates a scenario when the electric signal forces the diaphragm 43 to move towards the enclosure 3. This is indicated by arrows 4a. Then, the air within the enclosure 3 applies a pressure or force to the second surface 52 and to the diaphragm plate 61. This is indicated by arrows 5a.

FIG. 3 illustrates a scenario when the electric signal forces the diaphragm 43 to move away from the enclosure 3. This is indicated by arrows 4b. Then, the ambient air applies a pressure or force to the first surface 51 and to the diaphragm plate 61. This is indicated by arrows 5b.

Since the enclosure 3 is a closed enclosure 3, the pressure applied by the ambient air is less than the pressure applied by the air within the enclosure 3. This is indicated by the different lengths of the arrows 5a, 5b.

Particularly, the pressure applied to the diaphragm 43 by the air within the enclosure 3 is greater than the pressure applied by the ambient pressure. By means of the diaphragm plate 61 of the invention it is possible to influence the stiffness of the diaphragm 43 in such a way that the diaphragm 43 bends at least to a similar degree when moving towards or moving away from the enclosure 3.

Although modifications and changes may be suggested by those skilled in the art, it is the intention of the invention to embody within the patent warranted hereon all changes and modifications as reasonably and properly come within the scope of his contribution to the art.

What is claimed is:

1. A dynamic loudspeaker driver, comprising
a magnet system;
a membrane which comprises a diaphragm and a flexible annulus surrounding the diaphragm, the diaphragm being movably mounted with respect to the magnet system by means of the annulus;
a voice coil attached to the diaphragm and operatively coupled with the magnet system;
a diaphragm plate attached to the diaphragm, the diaphragm plate comprising a ceramic material.

2. The dynamic loudspeaker driver of claim 1, wherein the diaphragm has a first surface and a second surface, the second surface being opposite to the first surface, wherein the diaphragm plate is attached either to the first surface or the second surface of the diaphragm.

3. The dynamic loudspeaker driver of claim 2, wherein the diaphragm plate covers at least 80% of the first surface.

4. The dynamic loudspeaker driver according to claim 1, wherein the diaphragm plate comprises at least a first and a second layer, wherein one of the first and the second layer is made of the ceramic material and the other of the first and the second layer is made of an electrical conductive material.

5. The dynamic loudspeaker driver according to claim 1, wherein the diaphragm is a flat diaphragm and the diaphragm plate has a flat surface facing the diaphragm.

6. The dynamic loudspeaker driver according to claim 5, wherein the flat surface of the diaphragm plate has an area less than 2 cm².

7. The dynamic loudspeaker driver according to claim 1, wherein the diaphragm plate is of a circular, oval or rectangular shape.

8. The dynamic loudspeaker driver according to claim 1, wherein the ceramic material is an alumina ceramic or a hydrocarbon ceramic.

9. The dynamic loudspeaker driver according to claim 1, wherein the diaphragm plate has a thickness between 0.05 mm and 1.6 mm.

10. The dynamic loudspeaker driver according to claim 1, wherein the diaphragm plate has a flexural strength between 200 and 300 500 MPa.

11. The dynamic loudspeaker driver according to claim 1, wherein the diaphragm plate comprises an at least partially cupped or curved surface.

12. The dynamic loudspeaker driver according to claim 1, wherein the diaphragm comprises at least one opening.

13. A loudspeaker comprising an enclosure and a dynamic loudspeaker driver according to claim 1 mounted in the enclosure.

14. A mobile device comprising the loudspeaker of claim 13.
